(19) United States
(12) Patent Application Publication
(10) Pub. No.: US 2009/0117870 A1
(43) Pub. Date: May 7, 2009

(54) RECEIVER

(76) Inventors: Takeshi Ikeda, Tokyo (JP); Hiroshi Miyagi, Yokohama-shi (JP)

Correspondence Address: SMITH PATENT OFFICE, 1901 PENNSYLVANIA AVENUE N W, SUITE 901, WASHINGTON, DC, 20006, US

(21) Appl. No.: 12/266,346

(22) Filed: Nov. 6, 2008

(30) Foreign Application Priority Data
Nov. 6, 2007 (JP) 2007-288116

(51) Int. Cl. H04B 1/26

(52) U.S. Cl. 455/313

(57) ABSTRACT

There are provided an IF signal generating portion 10 for generating an intermediate frequency signal, and an amplitude error correcting portion 15 for setting a gain of an amplitude correcting portion 12 to eliminate an amplitude error between a signal processed by a first signal processing system for an I signal and a signal processed by a second signal processing system for a Q signal when the intermediate frequency signal generated by the IF signal generating portion 10 is selected by switches 7I and 7Q. By correcting an amplitude error using the intermediate frequency signal generated by the IF signal generating portion 10 in place of an intermediate frequency signal generated by processing an actual received signal, it is possible to accurately detect the amplitude error without an influence of a phase error by using a signal which does not include a phase error caused by a variation in elements of mixers 4I and 4Q and a 90° phase shifter 6 themselves.

### FIELD OF THE INVENTION

The present invention relates to a receiver and more particularly to a receiver for distributing a received signal having a radio frequency into an in-phase component and a quadrature component by means of two mixers to carry out a frequency conversion and performing a quadrature demodulation by using an in-phase signal and a quadrature signal which are obtained.

### DESCRIPTION OF THE RELATED ART

In general, a so-called modulation processing for converting a baseband signal (a low frequency signal including a DC vicinal component) into a radio frequency signal is indispensable to transmit information as a wireless electric wave signal. In a receiver for receiving, as an electric wave, the radio frequency signal generated by the modulation processing, a radio frequency signal received by a receiving antenna and a local oscillating signal output from a local oscillator are subjected to frequency mixing through a mixer to carry out a conversion into frequencies which are suitable for a detection (demodulation) processing.

In a receiver employing a superheterodyne method which is one of detecting methods, a radio frequency signal which is received and a local oscillating signal having a frequency (a local frequency) having a difference from a center frequency (a desirable received frequency) by a predetermined frequency are subjected to the frequency mixing so that the radio frequency signal is converted into an intermediate frequency signal. A receiver employing a direct detecting method has a structure in which almost the same frequency as a desirable received frequency is used for a local frequency of a local oscillating signal to convert a radio frequency signal into a direct baseband signal, thereby carrying out a detection.

Referring to the direct detecting method, the desirable received frequency and the local frequency of a local oscillator are identical to each other. For this reason, there is a problem in that a part of the local oscillating signal leaks from an input side of a mixer and returns to the mixer again, and self-mixing with the local oscillating signal is carried out, resulting in an offset on the DC component of the baseband signal. In order to eliminate the problem of the DC offset, a low IF method has been proposed. Referring to the low IF method, the DC offset does not interfere with a desirable signal because the desirable signal is not present in the vicinity of the DC component.

A modulating method of converting a baseband signal into a radio frequency signal includes a quadrature modulation (an IQ modulation) for distributing the baseband signal into an I channel (an in-phase component) and a Q channel (a quadrature component) to carry out a modulation. FIG. 4 is a diagram showing an example of a conventional structure of a receiver for receiving a radio frequency signal modulated by the quadrature modulating method. FIG. 4 shows a structure of a receiver employing a superheterodyne method.

As shown in FIG. 4, the conventional receiver includes a receiving antenna 101, an LNA (Low Noise Amplifier) 102, a band-pass filter (BPF) 103, mixers 104I and 104Q, a local oscillator 105, a 90° phase shifter 106, low-pass filters (LPFs) 107I and 107Q, A/D converters 108I and 108Q, and a DSP (Digital Signal Processor) 109.

The LNA 102 amplifies a radio frequency signal received by the receiving antenna 101 and outputs the signal thus amplifies to the BPF 103. The BPF 103 filters the radio frequency signal output from the LNA 102 into a predetermined band and extracts a signal of a predetermined frequency band including a desirable received frequency, and outputs the extracted signal to the two mixers 104I and 104Q. The local oscillator 105 generates and outputs a local oscillating signal having a predetermined frequency. The 90° phase shifter 106 shifts a phase of the local oscillating signal output from the local oscillator 105 by 90° and outputs the signal thus obtained.

The first mixer 104I carries out frequency mixing over the radio frequency signal output from the BPF 103 and an in-phase local oscillating signal output from the local oscillator 105, thereby converting the radio frequency signal into an intermediate frequency signal. The intermediate frequency signal output from the first mixer 104I is a signal (hereinafter referred to as an I signal) having an in-phase component (an I channel) in which a phase is not shifted from a received signal.

The second mixer 104Q carries out the frequency mixing over the radio frequency signal output from the BPF 103 and a quadrature (with a phase shifted by 90°) local oscillating signal output from the 90° phase shifter 106, thereby converting the radio frequency signal into an intermediate frequency signal. The intermediate frequency signal output from the second mixer 104Q is a signal (hereinafter referred to as a Q signal) having a quadrature component (a Q channel) in which a phase is shifted from a received signal by 90°.

The LPFs 107I and 107Q filter the I signal and the Q signal which are output from the mixers 104I and 104Q and removes harmonics. The A/D converters 108I and 108Q convert, into digital signals, the I signal and the Q signal from which the harmonics are removed through the LPFs 107I and 107Q, and output a digital I signal and a digital Q signal. The DSP 109 carries out a demodulation processing through a digital signal processing by using the digital I signal and the digital Q signal which are output from the A/D converters 108I and 108Q and thus outputs a demodulating signal.

In the case in which the radio frequency signal is converted into the intermediate frequency signal through the mixers 104I and 104Q, an originally unnecessary component such as an image noise is generated in a frequency channel (a spurious point) having a certain frequency relationship with a desirable received frequency. There has conventionally been provided a receiver having a processing structure for removing the image noise. Moreover, there has also been proposed a technique for removing the image noise through a digital signal processing to enhance an image removing ratio. Examples of a method of carrying out an image removal through the digital signal processing include a method of carrying out a complex frequency conversion.

In order to effectively fulfill an image removing function through the frequency conversion, it is desirable that amplitudes of I and Q signals generated by the mixers 104I and 104Q and input to an image removing circuit should be accurately coincident with each other and phases of the I and Q signals should be shifted accurately by 90°. However, the mixers 104I and 104Q and the 90° phase shifter 106 are constituted by analog circuits. Moreover, analog circuits such as the LPFs 107I and 107Q are also present before the I and Q signals generated in the mixers 104I and 104Q are converted into digital signals. In some cases, therefore, an amplitude error is made between the I and Q signals input to the image removing circuit or a phase difference is not accurately set to be 90° due to a variation in an analog element or the like. In these cases, the image removing ratio is not sufficient.

In order to solve the problem, there has been proposed a receiver for detecting a phase error from digital signals having in-phase and quadrature components and correcting the phase error and detecting and correcting an amplitude error, thereby removing an image noise included in a received signal (for example, see Patent Document 1). Moreover, there has also been proposed a technique for comparing output values of the 90° phase shifter with each other through a detecting mixer, deciding a phase error based on the output through a CPU and controlling a phase correcting circuit by the CPU, thereby correcting the phase error through the 90° phase shifter (for example, see Patent Document 2).

[Patent Document 1] Japanese Laid-Open Patent Publication No. 2004-266416

[Patent Document 2] Japanese Laid-Open Patent Publication No. 2000-308626

### DISCLOSURE OF THE INVENTION

In the prior art described in the Patent Document 1, however, an amplitude error is detected from the I and Q signals including both the phase error and the amplitude error and is corrected. For this reason, an amplitude error of a signal including the phase error is detected and an accurate amplitude error without the phase error is not detected. More specifically, even if the amplitude error is detected and corrected, the subsequently performed correction in the phase changes the amplitude correspondingly. Therefore, there is a problem in that an accurate amplitude correction cannot be carried out through the amplitude error detected with the phase error included.

In the prior arts described in the Patent Documents 1 and 2, moreover, the phase error itself between the I and Q signals is detected to carry out a phase correction. If precision in the detection of the phase error is poor, therefore, a phase difference between the I and Q signals cannot be accurately set to be 90°. As described in the Patent Document 1, it is necessary to set the phase error to be approximately 0.05° or less in order to ensure an image removing ratio of approximately 60 dB or more, for example. However, it is hard to ensure precision for detecting such a small phase error. For this reason, there is also a problem in that an accurate phase correction cannot be carried out.

In order to solve the problems, it is an object of the present invention to accurately correct a phase error and an amplitude error between I and Q signals, thereby suppressing an image noise effectively.

In order to attain the object, the present invention includes an intermediate frequency signal generating portion for generating a signal having the same intermediate frequency as an intermediate frequency signal generated by a mixer, a switching portion for selecting and outputting either the intermediate frequency signal generated by the mixer or the intermediate frequency signal generated by the intermediate frequency signal generating portion, an amplitude correcting portion for correcting an amplitude of at least one of in-phase and quadrature signals which are generated by the mixer in accordance with a set gain, and an amplitude error correcting portion for setting a gain of the amplitude correcting portion to eliminate an amplitude error between a signal processed by a first signal processing system for the in-phase signal and a signal processed by a second signal processing system for the quadrature signal when the intermediate frequency signal generated by the intermediate frequency signal generating portion is selected by the switching portion.

According to another aspect of the present invention, there are provided a synthesizing portion for synthesizing an in-phase signal processed by a first signal processing system and a quadrature signal processed by a second signal processing system, an image signal generating portion for generating a signal having an image frequency determined in a relationship between a received frequency and a local frequency, a second switching portion for selecting either a received signal or the image signal generated by the image signal generating portion and outputting the selected signal to a mixer, and a phase error correcting portion for correcting a phase error between the in-phase signal and the quadrature signal to minimize an energy of a signal output from the synthesizing portion when the image signal generated by the image signal generating portion is selected by the second switching portion.

According to the present invention having the structure described above, in place of the intermediate frequency signal generated by processing an actual received signal through the mixer, the signal having the same intermediate frequency which is generated by the intermediate frequency signal generating portion is selected by the switching portion and a signal processing after the mixer is carried out for the selected intermediate frequency signal. A gain of the amplitude correcting portion is controlled to eliminate the amplitude error by using the signal subjected to the signal processing. Since a signal to be processed at this time does not pass through the mixer, it does not include a phase error caused by a variation in elements of the 90° phase shifter and the mixer themselves. Consequently, it is possible to accurately detect the amplitude error caused by a variation in an analog element in a signal processing system after the mixer or the like without an influence of the phase error. Accordingly, it is possible to carry out an accurate amplitude correction, thereby enhancing an image noise removing effect.

According to another aspect of the present invention, the signal having the image frequency which is generated by the image signal generating portion is input to the mixer in place of an actual received signal input to the mixer through a selection in the second switching portion, and a serial signal processing is thus carried out for the image signal. Then, an in-phase signal and a quadrature signal which are subjected to the signal processing are synthesized and a phase error between the in-phase signal and the quadrature signal is corrected to minimize an energy of the synthesized signal. An energy of a signal obtained as a result of the processing of the image signal is minimized when the phase difference between the in-phase signal and the quadrature signal is 90°. By adjusting a phase to minimize the energy, therefore, it is possible to accurately set the phase difference between the in-phase signal and the quadrature signal to be 90° as a result. Consequently, it is possible to accurately correct a phase error caused by a variation in analog elements in the 90° phase shifter, the mixer and the like, thereby enhancing an image noise removing effect without requiring to detect the phase error itself between the in-phase signal and the quadrature signal.

### BRIEF DESCRIPTION OF THE DRAWINGS

FIG. 1 is a diagram showing an example of a structure of a receiver according to a first embodiment,

FIG. 2 is a diagram showing an example of a structure of a receiver according to a second embodiment,

FIG. 3 is a diagram showing an example of a structure of a receiver according to a third embodiment, and

FIG. 4 is a diagram showing an example of a structure of a conventional receiver.

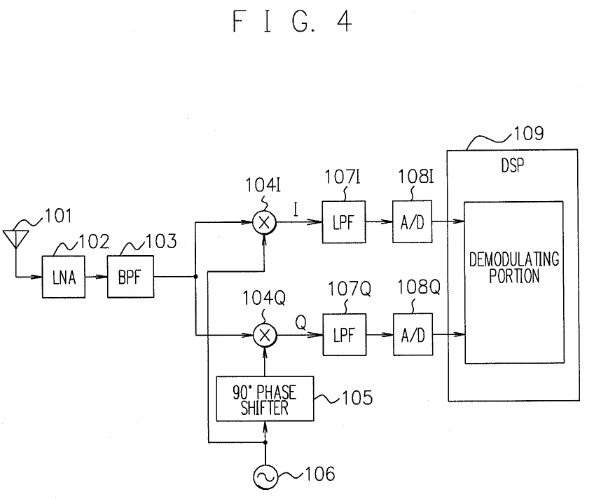

### BEST MODE FOR CARRYING OUT THE INVENTION

### First Embodiment

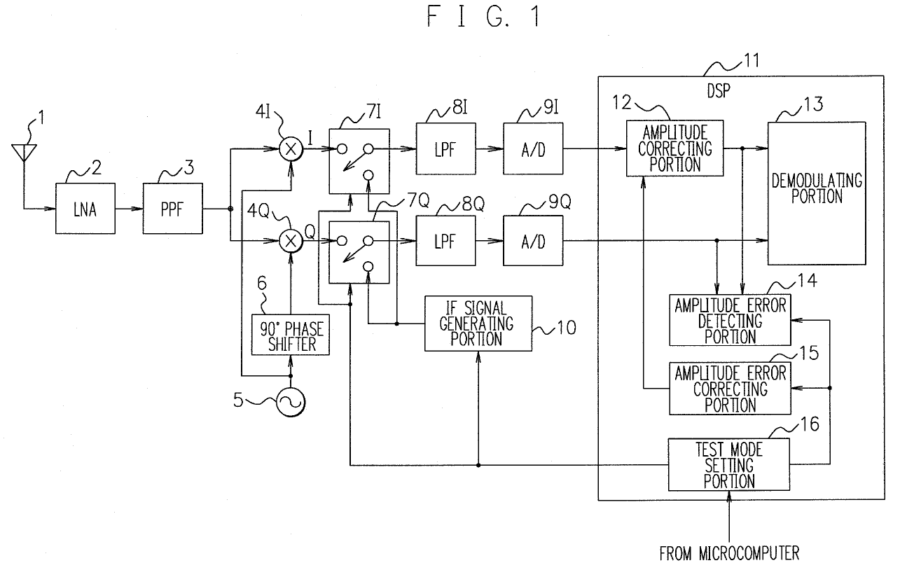

A first embodiment according to the present invention will be described below with reference to the drawings. FIG. 1 is a diagram showing an example of a structure of a receiver according to the first embodiment. As shown in FIG. 1, the receiver according to the first embodiment includes a receiving antenna 1, an LNA 2, a polyphase filter (PPF) 3, mixers 4I and 4Q, a local oscillator 5, a 90° phase shifter 6, switches 7I and 7Q, LPFs 8I and 8Q, A/D converters 9I and 9Q, an IF signal generating portion 10, and a DSP 11. The structures shown in FIG. 1 excluding the receiving antenna 1 are integrated into a single chip through a CMOS (Complementary Metal Oxide Semiconductor) process, for example.

The LNA 2 amplifies a radio frequency signal received by the receiving antenna 1 and supplies the signal thus amplifies to the PPF 3. The PPF 3 filters the radio frequency signal output from the LNA 2 into a predetermined band and extracts a signal of a predetermined frequency band including a desirable received frequency, and outputs the extracted signal to the first and second mixers 4I and 4Q. The local oscillator 5 generates and outputs a local oscillating signal of a local frequency having an offset in a predetermined frequency from a received frequency (which will be hereinafter referred to as an in-phase local oscillating signal) The 90° phase shifter 6 generates and outputs a signal obtained by shifting a phase of the in-phase local oscillating signal output from the local oscillator 5 by 90° (which will be hereinafter referred to as a quadrature local oscillating signal).

The first and second mixers 4I and 4Q carry out a frequency conversion from a received signal into an intermediate frequency signal with the in-phase local oscillating signal and the quadrature local oscillating signal and generates, from the received signal, I and Q signals constituted by in-phase and quadrature components having an intermediate frequency, respectively. More specifically, the first mixer 4I carries out frequency mixing over the radio frequency signal output from the PPF 3 and the in-phase local oscillating signal output from the local oscillator 5, thereby converting the radio frequency signal into an intermediate frequency signal. The intermediate frequency signal output from the first mixer 4I is an I signal having an in-phase component in which a phase is not shifted from the received signal. Moreover, the second mixer 4Q carries out the frequency mixing over the radio frequency signal output from the PPF 3 and the quadrature local oscillating signal output from the 90° phase shifter 6, thereby converting the radio frequency signal into an intermediate frequency signal. The intermediate frequency signal output from the second mixer 4Q is a Q signal having a quadrature component in which a phase is shifted from the received signal by 90°.

The I signal generated by the frequency conversion in the first mixer 4I is subjected to an analog signal processing through a first signal processing system constituted by the first LPF 8I and the first A/D converter 9I via the first switch 7I. Moreover, the Q signal generated by the frequency conversion in the second mixer 4Q is subjected to the analog signal processing through a second signal processing system constituted by the second LPF 8Q and the second A/D converter 9Q via the second switch 7Q. The IF signal generating portion 10 (which corresponds to an intermediate frequency signal generating portion according to the present invention) generates a signal having the same intermediate frequency as the intermediate frequency signals (the I and Q signals) generated by the first and second mixers 4I and 4Q.

The switches 7I and 7Q (which correspond to a switching portion according to the present invention) select either the intermediate frequency signals (the I and Q signals) generated by the first and second mixers 4I and 4Q or the intermediate frequency signal generated by the IF signal generating portion 10 and outputs the selected signal to the first signal processing system and the second signal processing system. Either of the intermediate frequency signals is selected in accordance with a control signal supplied from the DSP 11.

The LPFs 8I and 8Q filter the intermediate frequency signals supplied through the switches 7I and 7Q (that is, the I and Q signals generated by the first and second mixers 4I and 4Q or the intermediate frequency signal generated by the IF signal generating portion 10) and remove harmonics. The A/D converters 9I and 9Q convert, into digital signals, the intermediate frequency signals from which the harmonics are removed by the LPFs 8I and 8Q.

The DSP 11 includes an amplitude correcting portion 12, a demodulating portion 13, an amplitude error detecting portion 14, an amplitude error correcting portion 15 and a test mode setting portion 16. The amplitude correcting portion 12 corrects an amplitude of the intermediate frequency signal processed by the first signal processing system in accordance with a gain set by the amplitude error correcting portion 15. The demodulating portion 13 carries out a demodulation processing through a digital signal processing by using the digital I signal supplied from the first A/D converter 9I through the amplitude correcting portion 12 and the digital Q signal supplied from the second A/D converter 9Q in a normal mode in which the I and Q signals supplied from the first and second mixers 4I and 4Q are selected by the switches 7I and 7Q. The demodulating portion 13 has a function for removing an image noise by a method of carrying out a complex frequency conversion, for example.

The amplitude error detecting portion 14 detects an amplitude error between the intermediate frequency signal processed by the first signal processing system (a signal output from the amplitude correcting portion 12) and the intermediate frequency signal processed by the second signal processing system (a signal output from the second A/D converter 9Q) in a test mode in which the intermediate frequency signal supplied from the IF signal generating portion 10 is selected by the switches 7I and 7Q. The amplitude error correcting portion 15 sets a gain of the amplitude correcting portion 12 to eliminate the amplitude error detected by the amplitude error detecting portion 14.

The test mode setting portion 16 sets the receiver into a test mode in accordance with an instruction signal sent from a microcomputer which is not shown. When the test mode is set, the test mode setting portion 16 carries out a control to operate the IF signal generating portion 10 and controls the switches 7I and 7Q to select the intermediate frequency signal generated from the IF signal generating portion 10. Moreover, the test mode setting portion 16 carries out a control to operate the amplitude error detecting portion 14 and the amplitude error correcting portion 15 in the DSP 11.

In a normal mode in which the test mode is not set, the test mode setting portion 16 brings the IF signal generating portion 10 into a non-operation state and controls the switches 7I and 7Q to select the I and Q signals generated by the first and second mixers 4I and 4Q. When the normal mode is set, moreover, the amplitude error detecting portion 14 and the amplitude error correcting portion 15 in the DSP 11 are also brought into the non-operation state.

Next, description will be given to an operation of the receiver according to the first embodiment which has the structure described above. When the test mode is set by the test mode setting portion 16 in accordance with an instruction given from a microcomputer which is not shown, the IF signal generating portion 10 is operated to generate a signal having the same intermediate frequency as the I and Q signals generated by the first and second mixers 4I and 4Q. The intermediate frequency signal generated by the IF signal generating portion 10 is supplied to each of the switches 7I and 7Q. In the test mode, the switches 7I and 7Q are changed over to select the intermediate frequency signal generated by the IF signal generating portion 10. Consequently, the intermediate frequency signal generated by the IF signal generating portion 10 is supplied to both the first signal processing system and the second signal processing system.

An amplitude of the intermediate frequency signal processed in the test mode by the first signal processing system including the first LPF 8I and the first A/D converter 9I is corrected by the amplitude correcting portion 12 of the DSP 11 and the corrected intermediate frequency signal is then supplied to the amplitude error detecting portion 14. Moreover, the intermediate frequency signal processed in the test mode by the second signal processing system including the second LPF 8Q and the second A/D converter 9Q is supplied to the amplitude error detecting portion 14. An amplitude error between both of the intermediate frequency signals is detected by the amplitude error detecting portion 14.

The amplitude error correcting portion 15 sets a gain of the amplitude correcting portion 12 to eliminate the amplitude error detected by the amplitude error detecting portion 14. Consequently, the amplitude of the intermediate frequency signal processed by the first signal processing system is coincident with that of the intermediate frequency signal processed by the second signal processing system. Thus, the operation in the test mode is ended. The gain set to the amplitude correcting portion 12 in the test mode is also held after a cancellation of the test mode.

When the normal mode is set after the cancellation of the test mode, the IF signal generating portion 10, and the amplitude error detecting portion 14 and the amplitude error correcting portion 15 in the DSP 11 are brought into the non-operation state. Moreover, the switches 7I and 7Q are changed over to select the I and Q signals generated in the first and second mixers 4I and 4Q. Consequently, the I signal generated by the first mixer 4I is supplied to the first signal processing system and the Q signal generated by the second mixer 4Q is supplied to the second signal processing system.

The amplitude of the I signal processed by the first signal processing system is corrected by the amplitude correcting portion 12 in accordance with the gain set to the amplitude correcting portion 12 in the test mode, and the I signal is then supplied to the demodulating portion 13. Moreover, the Q signal processed by the second signal processing system is supplied to the demodulating portion 13 without a correction of an amplitude. Then, a demodulation processing is carried out by using the I and Q signals in the demodulating portion 13. The gain of the amplitude correcting portion 12 is controlled to eliminate the amplitude error between the signal processed by the first signal processing system and the signal processed by the second signal processing system. For this reason, the amplitudes of the I and Q signals input to the demodulating portion 13 are equal to each other. In the demodulating portion 13, a processing for removing an image noise through a complex frequency conversion is carried out by using the I and Q signals having the equal amplitudes, for example.

As described above in detail, according to the first embodiment, the intermediate frequency signal generated by the IF signal generating portion 10 is selected by the switches 7I and 7Q in place of the I and Q signals generated by processing an actual received signal through the mixers 4I and 4Q, and a signal processing after the mixers 4I and 4Q is carried out for the intermediate frequency signal when the test mode is set. At that time, the gain of the amplitude correcting portion 12 is controlled to eliminate the amplitude error between the signal processed by the first signal processing system and the signal processed by the second signal processing system.

Since the intermediate frequency signal to be processed in the test mode does not pass through the mixers 4I and 4Q, it does not include a phase error due to a variation in elements of the mixers 4I and 4Q and the 90° phase shifter 6 themselves. Consequently, the amplitude error detecting portion 14 of the DSP 11 can accurately detect an amplitude error caused by a variation in analog elements of the signal processing system after the mixers 4I and 4Q or the like without an influence of the phase error made by the mixers 4I and 4Q. Accordingly, the amplitude error correcting portion 15 can carry out an accurate amplitude correction, thereby enhancing an effect of an image removing function possessed by the demodulating portion 13.

Although the description has been given on the assumption that the amplitude correcting portion 12 corrects the amplitude of the intermediate frequency signal to be processed by the first signal processing system in the first embodiment, the present invention is not restricted thereto. For example, the amplitude correcting portion 12 may be provided in a subsequent stage to the second A/D converter 9Q in place of the subsequent stage to the first A/D converter 9I in order to correct the amplitude of the intermediate frequency signal to be processed by the second signal processing system. Moreover, the amplitude correcting portion 12 may be provided in the subsequent stages to the A/D converters 9I and 9Q respectively to correct both of the amplitudes of the intermediate frequency signals to be processed by the first and second signal processing systems.

Although the description has been given to the example in which the analog intermediate frequency signal is converted into the digital signal through the first A/D converter 9I and the amplitude is then corrected by the amplitude correcting portion 12 of the DSP 11 in the first embodiment, moreover, the present invention is not restricted thereto. For example, the amplitude correcting portion may be provided in a subsequent stage to the first LPF 8I to correct the amplitude for the analog intermediate frequency signal. In this case, in the same manner as the variant described above, it is also possible to correct the amplitude for the intermediate frequency signal output from the second LPF 8Q or to correct the amplitudes for the intermediate frequency signals output from the LPFs 8I and 8Q, respectively.

### Second Embodiment

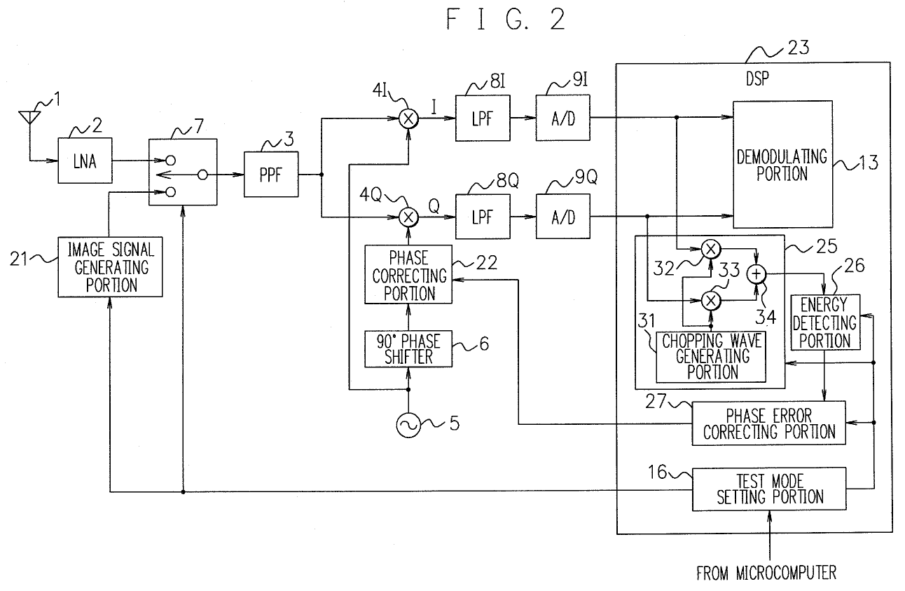

Next, a second embodiment according to the present invention will be described with reference to the drawings. FIG. 2 is a diagram showing an example of a structure of a receiver according to the second embodiment. In FIG. 2, since components having the same reference numerals as those shown in FIG. 1 have the same functions, repetitive description will be omitted.

As shown in FIG. 2, the receiver according to the second embodiment includes a receiving antenna 1, an LNA 2, a PPF 3, mixers 4I and 4Q, a local oscillator 5, a 90° phase shifter 6, a switch 7, LPFs 8I and 8Q, A/D converters 9I and 9Q, an image signal generating portion 21, a phase correcting portion 22 and a DSP 23. The structures shown in FIG. 2 excluding the receiving antenna 1 are integrated into a single chip through a CMOS process, for example.

The image signal generating portion 21 generates a signal having an image frequency determined in a relationship between a received frequency of a signal received through the receiving antenna 1 and the LNA 2 and a local frequency of the local oscillator 5. More specifically, in the case in which a radio frequency signal is converted into an intermediate frequency signal through the mixers 4I and 4Q, an image noise is caused to occur in a frequency channel having a certain frequency relationship with the received frequency. The image signal generating portion 21 generates a signal having the same frequency as the image noise (which will be hereinafter referred to as an image signal).

The switch 7 (which corresponds to a second switching portion according to the present invention) selects either the received signal output from the LNA 2 or the image signal generated by the image signal generating portion 21 and outputs the selected signal to the PPF 3. The phase correcting portion 22 corrects a phase of a quadrature local oscillating signal output from the 90° phase shifter 6 in accordance with a correction amount set by the DSP 23.

The DSP 23 includes a demodulating portion 13, a test mode setting portion 16, a synthesizing portion 25, an energy detecting portion 26 and a phase error correcting portion 27. The demodulating portion 13 carries out a demodulation processing through a digital signal processing by using digital I and Q signals supplied from the A/D converters 9I and 9Q in a normal mode in which the received signal sent from the LNA 2 is selected by the switch 7. The demodulating portion 13 has a function for removing an image noise by a method of carrying out a complex frequency conversion, for example.

The synthesizing portion 25 synthesizes the I and Q signals generated through the frequency conversion in the first and second mixers 4I and 4Q and processed by first and second signal processing systems in a test mode in which the image signal sent from the image signal generating portion 21 is selected by the switch 7. More specifically, the synthesizing portion 25 is constituted by a chopping wave generating portion 31, mixers 32 and 33, and an adder 34. The chopping wave generating portion 31 generates an in-phase cos wave at a comparatively low frequency and supplies the in-phase cos wave to the respective mixers 32 and 33. The chopping wave generating portion 31 has cos table information, for example, and generates a cos(ωt) chopping wave by using the table information.

The mixers 32 and 33 carry out mixing over the I and Q signals output from the A/D converters 9I and 9Q by using the in-phase chopping wave cos(ωt) input from the chopping wave generating portion 31. The adder 34 adds the I and Q signals subjected to the mixing through the in-phase chopping wave cos(ωt) by the mixers 32 and 33, thereby obtaining a real number component of a synthesized signal of the I and Q signals.

Although the description has been given to the example in which the chopping wave generating portion 31 generates the in-phase cos wave and carries out the mixing over the I and Q signals by using the in-phase chopping wave cos(ωt) to obtain the real number component of the synthesized signal, the present invention is not restricted thereto. For example, the chopping wave generating portion 31 may generate a quadrature sin wave and may carry out the mixing over the I and Q signals by using a quadrature chopping wave sin(ωt), thereby obtaining a complex component of the synthesized signal.

The energy detecting portion 26 detects an energy (a power) of a synthesized signal output from the synthesizing portion 25. The phase error correcting portion 27 sets a correction amount of the phase correcting portion 22 to minimize the energy of the synthesized signal detected by the energy detecting portion 26.

The test mode setting portion 16 sets the receiver into a test mode in accordance with an instruction signal sent from a microcomputer which is not shown. When the test mode is set, the test mode setting portion 16 carries out a control to operate the image signal generating portion 21 and controls the switch 7 to select the image signal generated by the image signal generating portion 21. Moreover, the test mode setting portion 16 carries out a control to operate the synthesizing portion 25, the energy detecting portion 26 and the phase error correcting portion 27 in the DSP 23.

In a normal mode in which the test mode is not set, the test mode setting portion 16 brings the image signal generating portion 21 into a non-operation state and controls the switch 7 to select the received signal output from the LNA 2. When the normal mode is set, moreover, the synthesizing portion 25, the energy detecting portion 26 and the phase error correcting portion 27 in the DSP 23 are also brought into the non-operation state.

Next, description will be given to an operation of the receiver according to the second embodiment which has the structure described above. When the test mode is set by the test mode setting portion 16 in accordance with an instruction given from a microcomputer which is not shown, the image signal generating portion 21 is operated so that an image signal having the same frequency as an image noise is caused to occur. The image signal generated by the image signal generating portion 21 is supplied to the switch 7. At this time, the switch 7 is changed over to select the image signal generated by the image signal generating portion 21. Accordingly, the image signal generated by the image signal generating portion 21 is supplied to the PPF 3.

Consequently, the I and Q signals are generated from the image signal output from the image signal generating portion 21 through the processings of the PPF 3 and the first and second mixers 4I and 4Q connected in a subsequent stage thereto. Then, the I and Q signals are processed by the first signal processing system and the second signal processing system respectively, and they are then supplied as digital I and Q signals to the DSP 23. In the DSP 23, the I and Q signals are synthesized by the synthesizing portion 25 and an energy of the synthesized signal is detected by the energy detecting portion 26.

The phase error correcting portion 27 sets the correction amount of the phase correcting portion 22 to minimize the energy detected by the energy detecting portion 26. Consequently, a phase difference between the I signal processed by the first signal processing system and the Q signal processed by the second signal processing system is exactly 90°. Thus, the operation in the test mode is ended. The phase correction amount set to the phase correcting portion 22 in the test mode is also held after a cancellation of the test mode.

When a normal mode is set after the cancellation of the test mode, the image signal generating portion 21, and the synthesizing portion 25, the energy detecting portion 26 and the phase error correcting portion 27 in the DSP 23 are brought into a non-operation state. Moreover, the switch 7 is changed over to select the received signal output from the LNA 2. Consequently, the received signal output from the LNA 2 is supplied to the PPF 3.

The received signal output from the LNA 2 through the switch 7 is subjected to filtering in the PPF 3 and is then subjected to a frequency conversion in the first and second mixers 4I and 4Q. Consequently, I and Q signals having an intermediate frequency are generated from the received signal. In the frequency conversion processing, a phase of the quadrature local oscillating signal supplied to the second mixer 4Q is corrected in accordance with the correction amount set to the phase correcting portion 22 in the test mode.

The I and Q signals generated by the first and second mixers 4I and 4Q are processed by the first signal processing system and the second signal processing system respectively and are then supplied as digital I and Q signals to the DSP 23. Thereafter, a demodulation processing is carried out by using the I and Q signals in the demodulating portion 13. In the demodulation, a processing for removing an image noise through a complex frequency conversion is carried out by using the I and Q signals in which a phase difference is accurately set to be 90° by the phase correcting portion 22, for example.

As described above in detail, according to the second embodiment, an actual received signal is not input to the mixers 4I and 4Q but the image signal generated by the image signal generating portion 21 is input to the mixers 4I and 4Q and a serial signal processing is carried out for the image signal when the test mode is set. Then, the I and Q signals subjected to the signal processing are synthesized and the correction amount of the phase correcting portion 22 is set to minimize an energy of the synthesized signal.

When the phase difference between the I and Q signals is 90°, the energy of the synthesized signal obtained as a result of the processing of the image signal is minimized. By adjusting the phase of the quadrature local oscillating signal to minimize the energy, therefore, it is possible to accurately set the phase difference between the I and Q signals to be 90° as a result. Consequently, it is possible to accurately correct a phase error caused by a variation in analog elements in the mixers 4I and 4Q, the 90° phase shifter 6 and the like, thereby enhancing an image noise removing effect without requiring to detect a phase error itself between the I and Q signals.

In the second embodiment, moreover, a phase is not corrected by using a signal received actually by the receiving antenna 1 but the image signal is generated by the image signal generating portion 21 to previously correct the phase when the test mode is set. Consequently, it is also possible to produce an advantage that the phase does not need to be corrected in the case in which the receiver is actually used.

Although the description has been given on the assumption that the phase correcting portion 22 corrects the phase of the quadrature local oscillating signal supplied from the 90° phase shifter 6 to the second mixer 4Q in the second embodiment, the present invention is not restricted thereto. For example, the phase correcting portion 22 may be provided on a path to the first mixer 4I in a subsequent stage to the local oscillator 5 in place of the subsequent stage to the 90° phase shifter 6 in order to correct the phase of the in-phase local oscillating signal supplied from the local oscillator 5 to the first mixer 4I. Moreover, the phase correcting portion 22 may be provided in the subsequent stages to the local oscillator 5 and the 90° phase shifter 6 respectively in order to correct both of the phases of the in-phase local oscillating signal and the quadrature local oscillating signal.

Although the description has been given to the example in which the phase of the local oscillating signal is corrected on an analog basis in the second embodiment, furthermore, the present invention is not restricted thereto. For example, in the DSP 23, a phase correcting portion may be provided in a subsequent stage to the first A/D converter 9I and/or the second A/D converter 9Q in order to correct a phase through a digital signal processing for either or both of the I and Q signals processed by the first and second signal processing systems.

### Third Embodiment

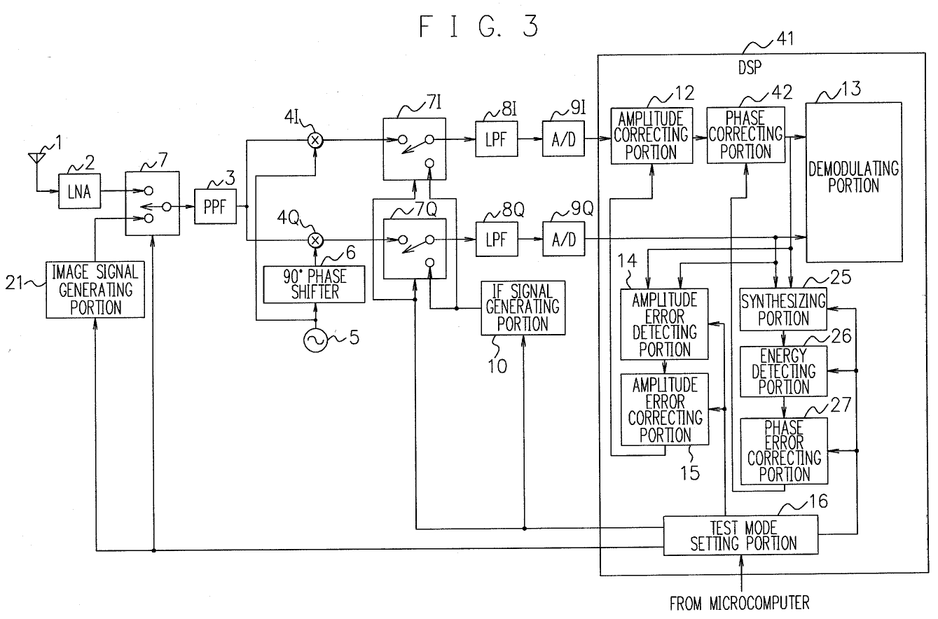

Next, a third embodiment according to the present invention will be described with reference to the drawings. FIG. 3 is a diagram showing an example of a structure of a receiver according to the third embodiment. In FIG. 3, since components having the same reference numerals as those shown in FIGS. 1 and 2 have the same functions, repetitive description will be omitted. In the third embodiment, the functions described in the first and second embodiments are added together.

As shown in FIG. 3, in a receiver according to the third embodiment, the phase correcting portion 22 is not provided in the subsequent stage to the 90° phase shifter 6 but a phase correcting portion 42 is provided as a processing function of a DSP 41 to correct a phase of an I signal processed by a first signal processing system in accordance with a correction amount set by a phase error correcting portion 27. As a matter of course, the phase correcting portion 22 may be provided in the subsequent stage to the 90° phase shifter 6 in the same manner as in the second embodiment.

An operation of the receiver according to the third embodiment will be described below. When a test mode is set by a test mode setting portion 16 in accordance with an instruction given from a microcomputer which is not shown, an IF signal generating portion 10 is first operated to generate a signal having the same intermediate frequency as I and Q signals generated by mixers 4I and 4Q. At this time, switches 7I and 7Q are changed over to select an intermediate frequency signal generated by the IF signal generating portion 10. Consequently, the intermediate frequency signal generated by the IF signal generating portion 10 is supplied to both the first signal processing system and the second signal processing system.

At this time, an amplitude error detecting portion 14 and an amplitude error correcting portion 15 in the DSP 41 are brought into an operation state. The amplitude error detecting portion 14 detects an amplitude error between the intermediate frequency signal processed by the first signal processing system and the intermediate frequency signal processed by the second signal processing system. The amplitude error correcting portion 15 sets a gain of an amplitude correcting portion 12 to eliminate the amplitude error detected by the amplitude error detecting portion 14. Consequently, an amplitude of the intermediate frequency signal processed by the first signal processing system is coincident with that of the intermediate frequency signal processed by the second signal processing system.

Next, the IF signal generating portion 10 and the amplitude error detecting portion 14 and the amplitude error correcting portion 15 in the DSP 41 are brought into a non-operation state, and an image signal generating portion 21 and a synthesizing portion 25, an energy detecting portion 26 and a phase error correcting portion 27 in the DSP 41 are brought into an operation state. At this time, the switches 7I and 7Q are changed over to select signals output from the first and second mixers 4I and 4Q. Moreover, the switch 7 is changed over to select an image signal generated by the image signal generating portion 21. Accordingly, the image signal generated by the image signal generating portion 21 is supplied to the first and second mixers 4I and 4Q.

Consequently, the I and Q signals are generated from the image signal output from the image signal generating portion 21 through the processings in the first and second mixers 4I and 4Q. The I and Q signals thus generated are output to the first and second signal processing systems through the switches 7I and 7Q, respectively. Subsequently, the I and Q signals are processed by the first signal processing system and the second signal processing system respectively and are then supplied as digital I and Q signals to the DSP 41.

In the DSP 41, an energy of a synthesized signal of the I and Q signals is detected by the synthesizing portion 25 and the energy detecting portion 26 and a correction amount of the phase correcting portion 42 is set to minimize the energy through the phase error correcting portion 27 in the same procedure described in the second embodiment. Consequently, a phase difference between the I signal processed by the first signal processing system and the Q signal processed by the second signal processing system is exactly 90°. Thus, the operation in the test mode is ended. A gain set to the amplitude correcting portion 12 and a phase correction amount set to the phase correcting portion 42 in the test mode are also held after a cancellation of the test mode.

When a normal mode is set after the cancellation of the test mode, the IF signal generating portion 10, the image signal generating portion 21, and the amplitude error detecting portion 14, the amplitude error correcting portion 15, the synthesizing portion 25, the energy detecting portion 26 and the phase error correcting portion 27 in the DSP 41 are brought into a non-operation state. Moreover, the switch 7 is changed over to select a received signal output from an LNA 2, and the switches 7I and 7Q are changed over to select the I and Q signals output from the mixers 4I and 4Q. Consequently, the received signal output from the LNA 2 is supplied to the mixers 4I and 4Q through a PPF 3.

The received signal output from the LNA 2 through the switch 7 and the PPF 3 is subjected to a frequency conversion through the first and second mixers 4I and 4Q. Consequently, I and Q signals having an intermediate frequency are generated from the received signal. The I and Q signals generated from the first and second mixers 4I and 4Q pass through the switches 7I and 7Q and are then processed by the first signal processing system and the second signal processing system respectively, and are thereafter supplied as digital I and Q signals to the DSP 41. Subsequently, the digital I signal is subjected to an amplitude correction through the amplitude correcting portion 12 and a phase is corrected by the phase correcting portion 22.

In a demodulating portion 13, a demodulation processing is carried out by using the I signal subjected to the amplitude correction and the phase correction after an A/D conversion in a first A/D converter 9I and the Q signal subjected to an A/D conversion in a second A/D converter 9Q. In the demodulation, a processing for removing an image noise through a complex frequency conversion is carried out by using the I and Q signals having amplitudes set to be uniform through the amplitude correcting portion 12 and a phase difference set accurately to be 90° through the phase correcting portion 42, for example.

As described above in detail, according to the third embodiment, it is possible to accurately detect and correct the amplitude error between the I and Q signals and to then correct the phase error accurately based on the energy of the synthesized signal of the I and Q signals when setting the test mode. More specifically, it is possible to accurately detect and correct both the amplitude error and the phase error which are caused by a variation in analog elements or the like, thereby enhancing an image noise removing effect through the frequency conversion in the DSP 41 still more.

The first to third embodiments are only illustrative for a materialization to carry out the present invention and the technical range of the present invention should not be thereby construed to be restrictive. More specifically, the present invention can be carried out in various forms without departing from the spirit or main features thereof.

### INDUSTRIAL APPLICABILITY

The present invention is useful for a receiver for distributing a received signal having a radio frequency into an in-phase component and a quadrature component through two mixers to carry out a frequency conversion, and performing a quadrature demodulation by using an in-phase signal and a quadrature signal which are obtained.

What is claimed is:

1. A receiver comprising:
a first mixer and a second mixer which frequency converts a received signal into an intermediate frequency signal with an in-phase local oscillating signal of a local frequency having an offset corresponding to an intermediate frequency from a received frequency and a quadrature local oscillating signal obtained by shifting a phase of the in-phase local oscillating signal by 90° and generating, from the received signal, an in-phase signal and a quadrature signal which have an intermediate frequency;
a first signal processing system for processing the in-phase signal generated through the frequency conversion in the first mixer;
a second signal processing system for processing the quadrature signal generated through the frequency conversion in the second mixer;
an intermediate frequency signal generating portion for generating a signal having the same intermediate frequency as the intermediate frequency signals generated by the first and second mixers;
a switching portion for selecting either the intermediate frequency signals generated by the first and second mixers or the intermediate frequency signal generated by the intermediate frequency signal generating portion and outputting the selected signal to the first signal processing system and the second signal processing system;
an amplitude correcting portion for correcting an amplitude of at least one of a signal to be processed by the first signal processing system and a signal to be processed by the second signal processing system in accordance with a set gain; and
an amplitude error correcting portion for setting a gain of the amplitude correcting portion to eliminate an amplitude error between the signal processed by the first signal processing system and the signal processed by the second signal processing system when the intermediate frequency signal generated by the intermediate frequency signal generating portion is selected by the switching portion.

2. The receiver according to claim 1, further comprising:
a synthesizing portion for synthesizing the in-phase signal processed by the first signal processing system and the quadrature signal processed by the second signal processing system when the intermediate frequency signals generated by the first and second mixers are selected by the switching portion;
an image signal generating portion for generating a signal having an image frequency determined in a relationship between the received frequency and the local frequency;
a second switching portion for selecting either the received signal or the image signal generated by the image signal generating portion and outputting the selected signal to the first and second mixers; and
a phase error correcting portion for correcting a phase error between the in-phase signal and the quadrature signal to minimize an energy of a signal output from the synthesizing portion when the image signal generated by the image signal generating portion is selected by the second switching portion.

3. The receiver according to claim 2, further comprising a phase correcting portion for correcting a phase of at least one of the in-phase signal processed by the first signal processing system and the quadrature signal processed by the second signal processing system in accordance with a set correction amount,
the phase error correcting portion setting a correction amount of the phase correcting portion to minimize an energy of a signal output from the synthesizing portion.

4. The receiver according to claim 2, further comprising:
a local oscillator for generating the in-phase local oscillating signal;
a 90° phase shifter for shifting a phase of the in-phase local oscillating signal by 90° to generate the quadrature local oscillating signal; and
a phase correcting portion for correcting a phase of at least one of the in-phase local oscillating signal output from the local oscillator and the quadrature local oscillating signal output from the 90° phase shifter in accordance with a set correction amount,
the phase error correcting portion setting a correction amount of the phase correcting portion to minimize the energy of the signal output from the synthesizing portion.

5. A receiver comprising:
a first mixer and a second mixer which frequency converts a received signal into an intermediate frequency signal with an in-phase local oscillating signal of a local frequency having an offset corresponding to an intermediate frequency from a received frequency and a quadrature local oscillating signal obtained by shifting a phase of the in-phase local oscillating signal by 90° and generating, from the received signal, an in-phase signal and a quadrature signal which have an intermediate frequency;
a first signal processing system for processing the in-phase signal generated through the frequency conversion in the first mixer;
a second signal processing system for processing the quadrature signal generated through the frequency conversion in the second mixer;
a synthesizing portion for synthesizing the in-phase signal processed by the first signal processing system and the quadrature signal processed by the second signal processing system;
an image signal generating portion for generating a signal having an image frequency determined in a relationship between the received frequency and the local frequency;
a switching portion for selecting either the received signal or the image signal generated by the image signal generating portion and outputting the selected signal to the first and second mixers; and
a phase error correcting portion for correcting a phase error between the in-phase signal and the quadrature signal to minimize an energy of a signal output from the synthesizing portion when the image signal generated by the image signal generating portion is selected by the switching portion.
